(19) United States
(12) Patent Application Publication
(10) Pub. No.: US 2011/0253780 A1
(43) Pub. Date: Oct. 20, 2011

(54) Card-reading device

(75) Inventors: Chun-Wei Kuan, Zhonghe City (TW); Yi-Hsiung Lo, Zhonghe City (TW); Kai-Yu Cheng, Taipei (TW)

(73) Assignee: Castles Technology Co., Ltd., Hsin-Tien (TW)

(21) Appl. No.: 12/761,405

(22) Filed: Apr. 16, 2010

(51) Int. Cl. G06K 7/01

(52) U.S. Cl. 235/435

(57) ABSTRACT

An improved card-reading device comprises an input module, a message display panel, a pair of engaging elements, a shielding structure and an antenna module. The shielding structure is pivotally installed between the pair of engaging elements, such that the shielding structure can be swung to provide a shielding effect to a specific position of the card-reading device. The antenna module is installed inside the shielding structure and provided for sensing an object containing a specific tag.

### BACKGROUND OF THE INVENTION

1. Field of the Invention

The present invention relates to an improved card-reading device, and more particularly to a card-reading device with a shielding structure integrated with a sensing antenna.

2. Description of the Related Art

As the world's economy grows rapidly with severe competitions, plastic money is a necessary tool used extensively for making payments or conducting business transactions in advanced districts and developed countries, and the plastic money is as important as paper money already. Since plastic money is very convenient and easy-to-carry, it also can serve as cash for most business transactions. Furthermore, it is inconvenient and often dangerous to carry a large amount of cash, and thus consumers prefer the use of plastic money.

For the use of plastic money, stores accepting credit cards must install a card reader for data exchange to process and transmit consuming data and received confirmation data, so that the stores can process follow-up procedures and request signatures from consumers to complete the transaction.

However, the entire electronic transaction process involves transmissions of personal data and business transaction data, so that there is a security concern, particularly for the card readers having a keyboard module, and stores or consumers have to operate the keyboard module to input specific data such as card number, password, dollar amount or other personal related data in order to process the business transaction. In general, the conventional keyboard type card reader usually does not come with any covering or shielding structure, and other people may peek at the operations or steal the consumer's personal data and transaction information easily, while the consumer is inputting data, and the consumers may suffer loss or damage.

In view of the drawbacks of the prior art, manufactures should provide a card reader with a shielding structure for providing a shielding effect to prevent others from peeking or stealing the inputted data during the processing of a business transaction, so as to improve the security of business transactions.

In recent years, integrated circuits are enhanced and miniaturized, and plastic money is integrated with small integrated circuits to produce a chip card in order to enhance the function and applicability of the plastic money. The application of chip cards advances constantly with consumer requirements, such that the advancement from contact type cards such as credit cards, automatic teller machine (ATM) cards and National Health Insurance (NHI) cards to contactless cards such as easy cards and access control cards, and combined cards such as VISA Wave cards, smart ID cards and electronic wallets are introduced recently.

In a contactless card reader, an antenna module is installed for reading data stored in a card through radio frequency transmissions to process a transaction, and the antenna module may be installed at any other appropriate position as needed.

In view of the shortcomings of the prior art, the inventor of the present invention based on years of experience in the related industry to conduct extensive researches and experiments, and finally developed an improved card-reading device that is integrated with a shielding structure and an antenna module to provide convenient operations and overcome the shortcomings of the prior art.

### SUMMARY OF THE INVENTION

The primary objective of the present invention is to provide an improved card-reading device and its shielding structure that provides a shielding effect for a specific position of the card-reading device to prevent the transaction information from being peeked or stolen during the operations of the transaction.

Another objective of the present invention is to provide an improved card-reading device and its shielding structure, wherein an antenna module is integrated into the shielding structure, so that the shielding structure can serve as a radio sensing base for the transaction to provide a multiple of functions.

To achieve the foregoing objectives, the present invention discloses an improved card-reading device, comprising: an input module being installed onto and exposed from the card-reading device for inputting specific information to perform operations of a card-reading procedure; a message display panel being installed onto and exposed from the card-reading device for displaying status information of performing the card-reading procedure; a pair of engaging elements being installed onto and exposed from the card-reading device; a shielding structure being pivotally disposed between the pair of engaging elements and capable of using a pivoting position as a rotating axis for a swing, and providing a shielding effect to specific positions of the card-reading device by different rotating angles; and an antenna module being installed inside the shielding structure for performing contactless detection of an object containing a specific tag and transmitting information of the detected tag to the card-reading device to perform the card-reading procedure.

### BRIEF DESCRIPTION OF THE DRAWINGS

FIG. 1 is a schematic perspective view of an improved card-reading in accordance with a first preferred embodiment of the present invention;

FIG. 2 is a schematic view of an illumination method of an illuminating element in accordance with the first preferred embodiment of the present invention;

FIG. 3A is another schematic view of a shielding structure swung to a angle with respect to the card-reading device in accordance with the first preferred embodiment of the present invention;

FIG. 3B is a further schematic view of a shielding structure swung to another angle with respect to the card-reading device in accordance with the first preferred embodiment of the present invention;

FIG. 4 is a schematic perspective view of the improved card-reading device in accordance with a second preferred embodiment of the present invention;

FIG. 5 is a schematic perspective view of the improved card-reading device in accordance with a third preferred embodiment of the present invention;

FIG. 6 is a schematic perspective view of the improved card-reading device in accordance with a fourth preferred embodiment of the present invention; and

FIG. 7 is another schematic perspective view of the improved card-reading device swung to a different angle in accordance with the fourth preferred embodiment of the present invention.

### DETAILED DESCRIPTION OF THE PREFERRED EMBODIMENTS

The structural assembly, overall operations and technical characteristics of the present invention will become apparent with the detailed description of the preferred embodiments and the illustration of the related drawings as follows.

In the present invention, an antenna module is integrated into a shielding structure to provide an improved card-reading device of the invention. First, second, third and fourth preferred embodiments of an improved card-reading device in accordance with the present invention are used for illustrating the system structure and technical contents of the invention as follows.

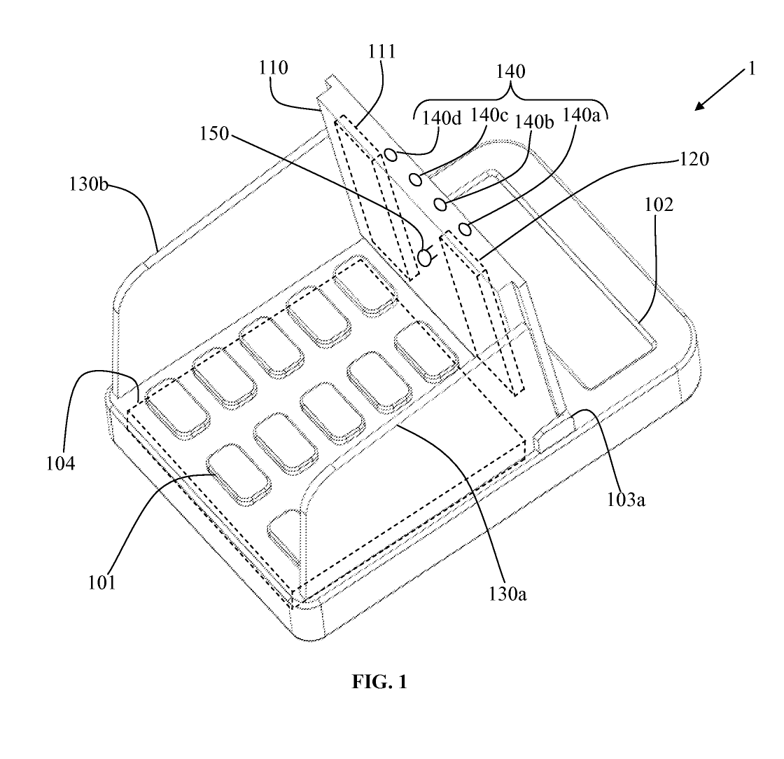

With reference to FIG. 1 for a perspective view of the improved card-reading device in accordance with the first preferred embodiment of the present invention, the card-reading device 1 comprises:

an input module 101, being installed onto and exposed from the card-reading device 1 for inputting specific information to perform operations of a card-reading procedure, wherein the input module 101 is a keyboard type input module provided for users to press and input the specific information; a message display panel 102, being installed onto and exposed from the card-reading device 1 for displaying status information of performing the card-reading procedure; a pair of engaging elements 103a (and only one engaging element 103a is shown in FIG. 1), being installed onto and exposed from the card-reading device 1, wherein its installation position is situated at the boundary that separates the input module 101 and the message display panel 102; a first circuit board 104, being installed inside the card-reading device 1 for supplying power and processing data;

a shielding structure 110, being pivotally coupled between the pair of engaging elements 103a, wherein the shielding structure 110 can be swung by using the pivoting position as an axis of rotation, and different swinging angles can be used for providing a shielding effect at specific positions of the card-reading device 1, and the engaging element 103a is installed at the boundary that separates the input module 101 and the message display panel 102, such that when the shielding structure 110 is pivotally installed between the pair of engaging elements 103a, different rotating angles can be used selectively for providing a shielding effect for the input module 101 and the message display panel 102, and the shielding structure 110 further includes a second circuit board 111 installed therein for supplying power and processing data;

an antenna module 120, being installed inside the shielding structure 110 for sensing an object containing a specific tag by contactless detection and transmitting the detected tag information to the card-reading device 1 for performing a card-reading procedure;

two fixing boards 130a, 130b, being urged between the shielding structure 110 and the card-reading device 1, such that the two fixing boards 130a, 130b can be provided for fixing the shielding structure 110 at a specific angle, and the two fixing boards 130a, 130b are installed on both sides of the input module 101 respectively to achieve a shielding effect for both sides of the input module 101;

a set of status indicating lights 140, being installed on the shielding structure 110, for indicating status information of a card-reading procedure, wherein the set of status indicating lights 140 are composed of light emitting diodes (LED) and each status indicating element 140a, 140b, 140c, 140d of the set of status indicating lights 140 can emit different color light sources to indicate different transaction statuses, so as to provide easy-to-view and convenient operations; and

an illuminating element 150, being installed on a surface of the shielding structure 110 that faces the input module 101 and provided for projecting a light source onto the input module 101.

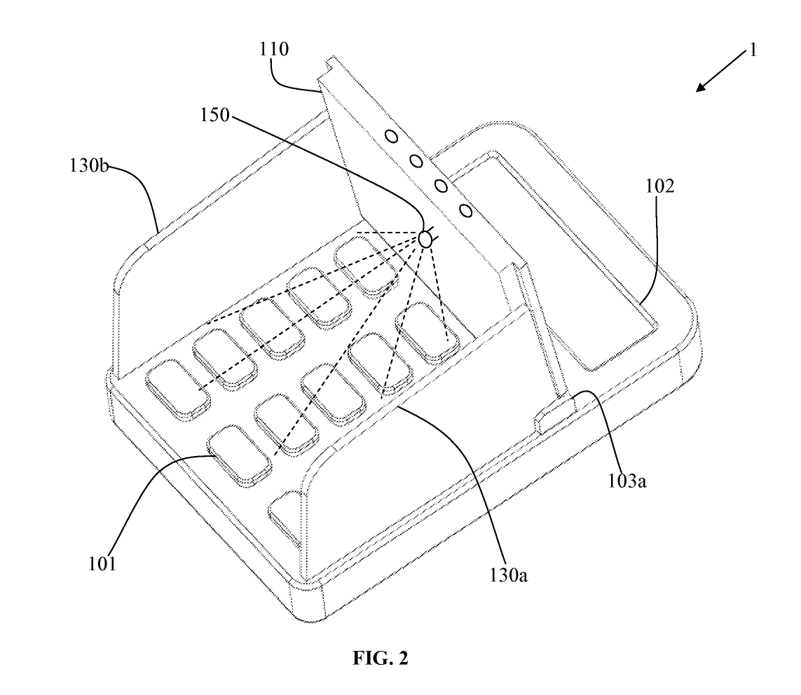

With reference to FIG. 2 for a schematic view of an illumination method of an illuminating element 150 in accordance with the first preferred embodiment of the present invention, when the shielding structure 110 and the left and right fixing boards 130a, 130b provide a shielding effect to the input module 101, the light projected onto the input module 101 may be blocked to lower the visibility of the operations, and the illuminating element 150 can project a light source onto the input module 101 to enhance the visibility for operating the input module 101.

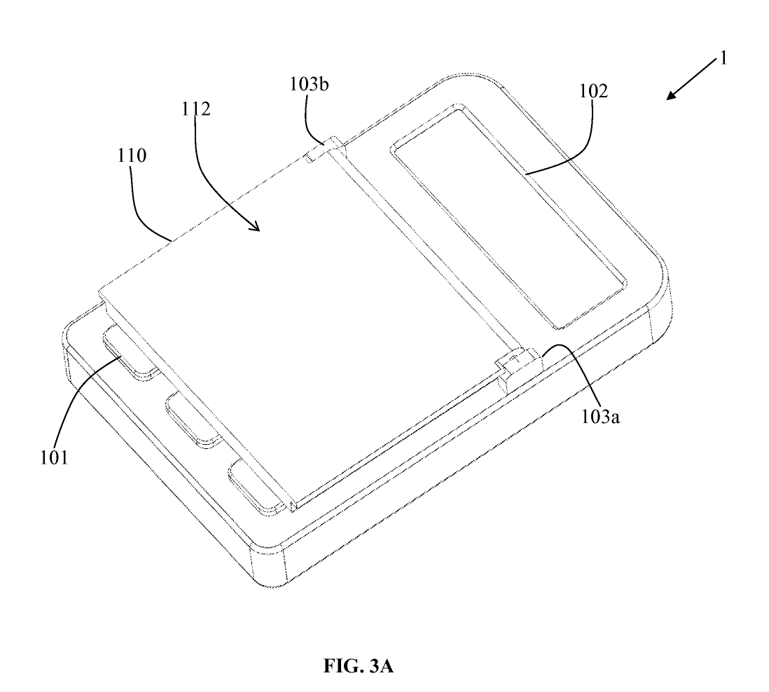

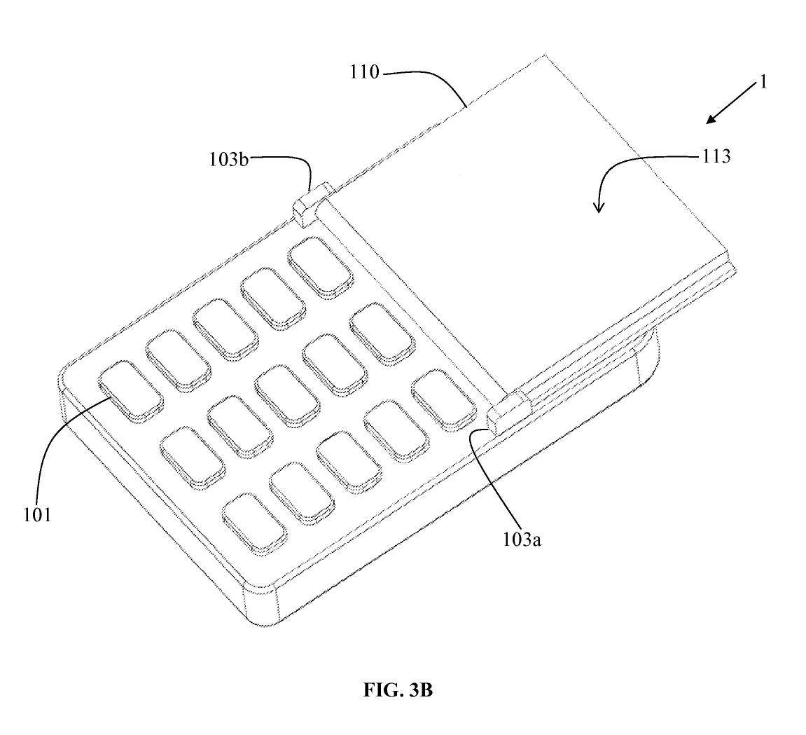

With reference to FIGS. 3A and 3B for schematic view of a shielding structure 110 swung at two different swinging angles with respect to a card-reading device 1 in accordance the first preferred embodiment of the present invention respectively, the shielding structure 110 can be swung to different angles by the pair of engaging elements 103a, 103b. Since the pair of engaging elements 103a, 103b are installed between the input module 101 and the message display panel 102, therefore when the shielding structure 110 is swung to a position as shown in FIG. 3A, the shielding structure 110 can protect the input module 101 from being collided or damaged, and when the shielding structure 110 is swung to a position as shown in FIG. 3 B, the shielding structure 110 can protect the message display panel 102 from being collided or damaged. In FIGS. 3A and 3B, each shielding structure 110 has a plane 112, 113 facing upward, so that the plane 112, 113 can be used as a detection platform, and an object containing a specific tag (such as a contactless card) can be placed on the plane 112, 113 to perform a contactless sensing business transaction.

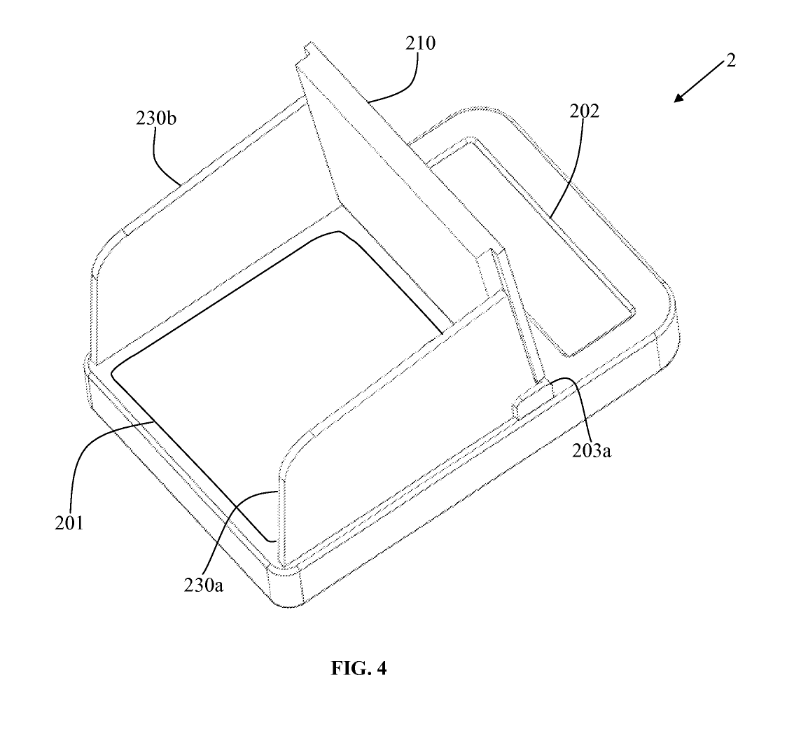

With reference to FIG. 4 for a perspective view of the improved card-reading device in accordance with the second preferred embodiment of the present invention, the structure of the second preferred embodiment is substantially the same as the structure of the first preferred embodiment and thus will not be described here again. Their difference resides on that an input module 201 of the second preferred embodiment is a touch panel provided for a user to input information required for a transaction by touching the touch panel.

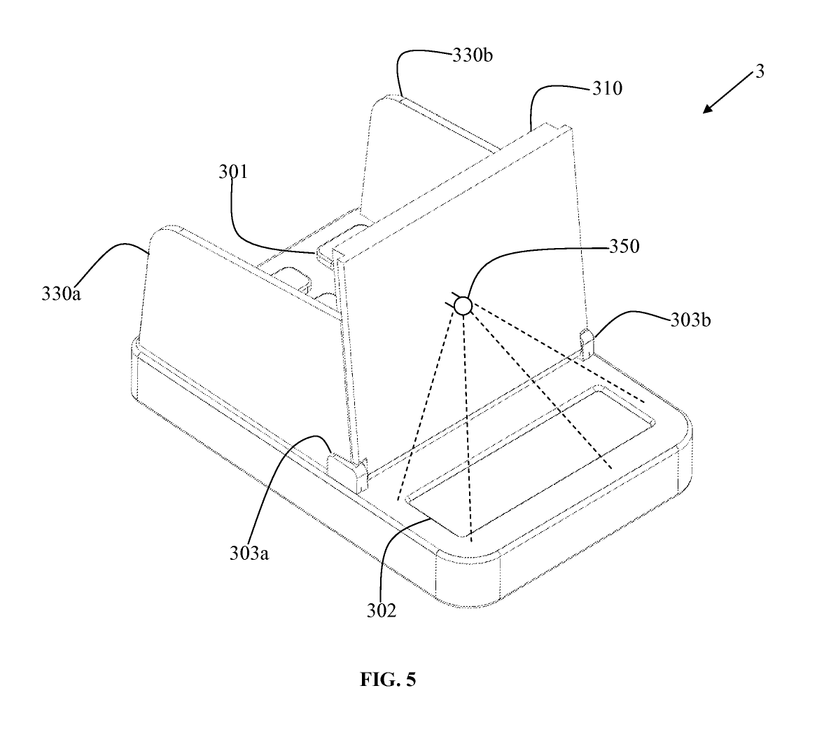

With reference to FIG. 5 for a perspective view of the improved card-reading device in accordance with the third preferred embodiment of the present invention, the structure of the third preferred embodiment is substantially the same as the structure of the first preferred embodiment, and thus will not be described again here. Their difference resides on that an illuminating element 350 of the third preferred embodiment is installed on a surface of the shielding structure 310 that faces a message display panel 302, such that when a card-reading device 3 is situated at a dark environment for operations, the illuminating element 350 can project a light source onto the message display panel 302 to improve the visibility of the displaced information.

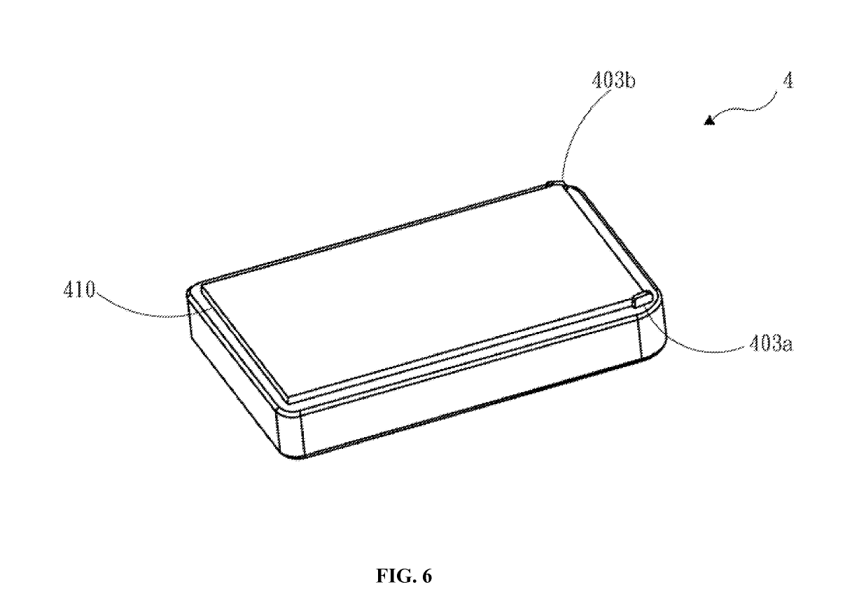

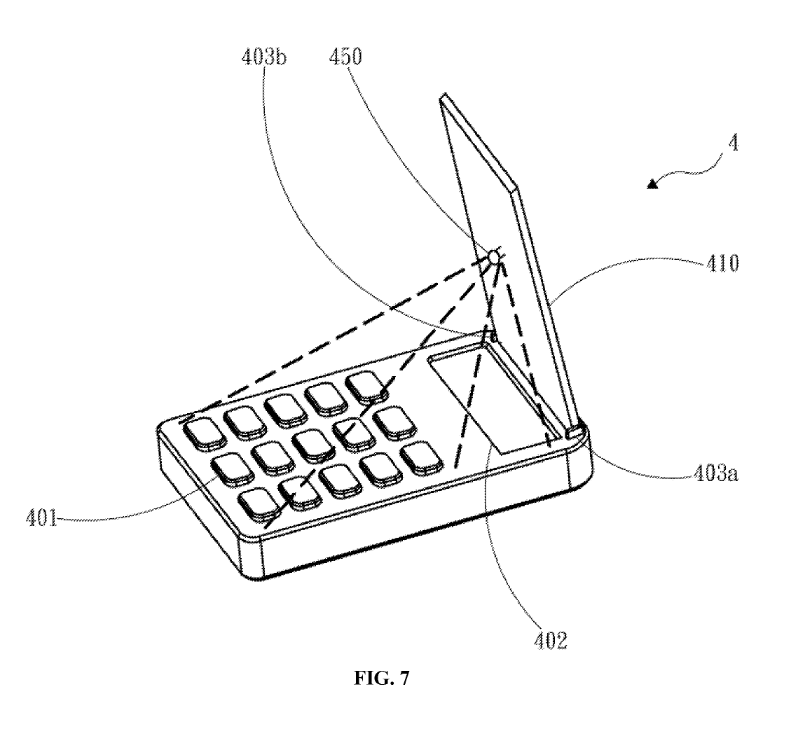

With reference to FIGS. 6 and 7 for schematic views of the improved card-reading device with different swinging angle in accordance with the fourth preferred embodiment of the present invention respectively, the structure of the fourth preferred embodiment is substantially the same as the structure of the first preferred embodiment, and thus will not be described again here. Their difference resides on that a pair of engaging elements 403a, 403b of the fourth preferred embodiment are installed on a side of a message display panel 402 opposite to another side of the message display panel that adjacent to an input module 401, and a shielding structure 410 is pivotally installed between the pair of engaging elements 403a, 403b as shown in FIG. 6, such that when the shielding structure 410 covers the input module 401 and the message display panel 402 completely, the input module 401 and the message display panel 402 can be protected from being collided. In FIG. 7, when the shielding structure 410 is swung to a specific angle, the shielding structure 410 can provide a shielding effect to the input module 401 and the message display panel 402. In addition, the shielding structure 410 further includes an illuminating element 450 installed on a surface of shielding structure 410 that faces the input module 401 and the message display panel 402, such that when the shielding structure 410 provides a shielding effect to the input module 401 and the message display panel 402, the light may be blocked to lower the visibility of the operations, and the illuminating element 450 can project a light source onto the input module 401 and the message display panel 402 to enhance the visibility of the operations.

In summation, the system structure and technical contents of the present invention have the following advantages:

1. The present invention includes the pivotally installed shielding structure, such that the shielding structure can be swung to different angles to provide shielding effects to different positions of the card-reading device, so as to prevent others from peeking.
2. The present invention integrates the antenna module into the shielding structure, and the plane of the shielding structure serves as a sensing platform to achieve a multi-functional effect.
3. The present invention integrates the status indicating lights into the shielding structure for providing an easy-to-view effect for a business transaction by indicating the transaction status.
4. The present invention integrates the illuminating element into the shielding structure for projecting a light source onto the input module or the message display panel to enhance the visibility of operations.

What is claimed is:

1. An improved card-reading device, comprising:
an input module, being installed onto and exposed from the card-reading device for inputting specific information to perform operations of a card-reading procedure;
a message display panel, being installed onto and exposed from the card-reading device for displaying status information of performing the card-reading procedure;
a pair of engaging elements, being installed onto and exposed from the card-reading device;
a shielding structure, being pivotally disposed between the pair of engaging elements and capable of using a pivoting position as a rotating axis for a swing, and providing a shielding effect to specific positions of the card-reading device by different swinging angles; and
an antenna module, being installed inside the shielding structure for performing contactless detection of an object containing a specific tag and transmitting the information of the detected tag to the card-reading device to perform the card-reading procedure.

2. The improved card-reading device according to claim 1, wherein the card-reading device further comprises a first circuit board installed therein and the shielding structure further comprises a second circuit board installed therein, the first circuit board and the second circuit board being provided for supplying power and processing data.

3. The improved card-reading device according to claim 1, wherein the input module is a keyboard type input module for inputting specific information by pressing a keyboard.

4. The improved card-reading device according to claim 1, wherein the input module is a touch panel provided for a user to enter information required for a business transaction by touching the touch panel.

5. The improved card-reading device according to claim 1, further comprising two fixing boards being urged between the shielding structure and the card-reading device, the two fixing boards can be then used for fixing the shielding structure at a specific angle.

6. The improved card-reading device according to claim 5, wherein the two fixing boards are installed on both sides of the input module respectively to achieve a shielding effect for both sides of the input module.

7. The improved card-reading device according to claim 1, wherein the shielding structure further comprises a set of status indicating lights provided for displaying status information of the card-reading procedure.

8. The improved card-reading device according to claim 7, wherein the set of status indicating lights are composed of light emitting diodes (LED).

9. The improved card-reading device according to claim 1, wherein the pair of engaging elements are installed at a boundary that separates the input module and the message display panel, when the shielding structure is pivotally installed between the pair of engaging elements, different swinging angles can be used for selectively providing a shielding effect to the input module and the message display panel.

10. The improved card-reading device according to claim 9, wherein the shielding structure further comprises an illuminating element installed on a surface of the shielding structure that faces the input module, when the shielding structure provides a shielding effect to the input module, a light projected onto the input module being blocked so as to cause lower visibility, and the illuminating element projecting a light source onto the input module to improve the visibility for operations of the input module.

11. The improved card-reading device according to claim 9, wherein the shielding structure further comprises an illuminating element installed on a surface of the shielding structure that faces the message display panel, when the card-reading device is situated at a dark environment for operations, the illuminating element projecting a light source onto the message display panel to improve the visibility of the displayed information.

12. The improved card-reading device according to claim 1, wherein the pair of engaging elements are installed on a side of the message display panel opposite to another side of the message display panel that adjacent to the input module and the shielding structure is pivotally installed between the pair of engaging elements, when the shielding structure covers the input module and the message display panel completely, the input module and the message display panel being protected from colliding, and when the shielding structure being swung to a specific angle, a shielding effect being provided to the input module and the message display panel.

13. The improved card-reading device according to claim 12, wherein the shielding structure further comprises an illuminating element installed on a surface of the shielding structure that faces the input module and the message display panel, when the shielding structure provides a shielding effect to the input module and the message display panel, a light being blocked to cause lower visibility of operations, and the illuminating element projecting a light onto the input module and the message display panel to improve the visibility of the operation.
